(19) United States
(12) Patent Application Publication
(10) Pub. No.: US 2016/0086245 A1
(43) Pub. Date: Mar. 24, 2016

(54) COMMUNICATIONS SERVER APPARATUS AND METHODS OF OPERATION THEREOF

(71) Applicant: GLOBALROAM PTE LTD, Singapore (SG)

(72) Inventors: Clarence TAN, Singapore (SG); Peng Leong LOO, Singapore (SG); Abdul QADIR, Sydney (AU)

(21) Appl. No.: 14/889,362

(22) PCT Filed: May 6, 2014
(86) PCT No.: PCT/SG2014/000197

§ 371 Date: Nov. 5, 2015

Related U.S. Application Data
(60) Provisional application No. 61/819,664, filed on May 6, 2013.

(30) Foreign Application Priority Data
May 7, 2013 (SG) 201303488-9

(51) Int. Cl. G06Q 30/06; H04L 29/08; H04L 29/06

(52) U.S. Cl. CPC G06Q 30/0613; H04L 65/1069; H04L 67/02; G06Q 30/0611

(57) ABSTRACT

A communications server apparatus comprises a processor and a memory. The communications server apparatus is configured, under control of the processor, to execute instructions stored in the memory to receive, over a communications channel, link information relating to a caller input, the caller input being activation of a link in a page by a caller, the link being associated with an offer, and activation of the link being a request for a voice communication session between the caller and a call recipient about the offer. The communications server apparatus identifies the call recipient using the link information and initiates the voice communication session between a caller device associated with the caller and a recipient device associated with the call recipient. Supplementary information relating to the activation of the link is transmitted to the recipient device.

The invention relates to a communications server apparatus for, responsive to activation of a link in a page by a caller, initiating a voice communication session between a caller device and a recipient device and transmitting, to the recipient device, supplementary information relating to the activation of the link. The invention also relates to a corresponding method of operation, a computer readable medium having stored thereon computer-readable instructions for executing the method, and a computer program comprising instructions for execution by a computing device to perform the method.

The invention has particular, but not exclusive, application in allowing a caller to make a simultaneous or near-simultaneous data call and voice or video call with a call recipient upon activation of a link (e.g. a hyperlink) on the caller's communications device. Hereafter, the term “voice call” is defined to encompass a voice communication session, whether or not a video component is transmitted to one or more of the calling parties as part of the communication session. In addition to the voice call, data (information) may be transmitted to one or more of the parties in a “data call”, hereafter defined to encompass the transmission of data other than voice and video data from one device to another, optionally through a data network such as the Internet. This information includes supplementary information relating to the activation of the link, as will be described in greater detail below.

The internet is the primary (but not only) example of a data network that is used by users for accessing information and for communicating. Voice calling through the Internet—whether accompanied by video signals or not—has become a very popular form of communication with the proliferation of VoIP technology because of the ability for users to communicate with one another in real-time.

Until recently, the internet was traditionally accessible via a data call using computers (PC, laptops, tablets, e-books etc.) while cellular/mobile or landline phones were used for voice calls. However with the advent of broadband internet and 3G (or higher generation) mobile communications, it is possible to make voice calls over the internet (VoIP, Skype etc.) and data calls by accessing the internet using mobile communications devices such as smart phones and tablets. In fact mobile devices can now be used to make simultaneous or near-simultaneous voice and data calls. Modern smart phones can run one or more applications (popularly known as “apps”) for making voice and/or data calls. Systems have also disclosed whereby a data call is used to set-up a voice call. Such systems can either be web-based or be “app” based that run on mobile devices. Related techniques are disclosed in U.S. Pat. No. 7,996,013 and U.S. Pat. No. 6,192,123. Other related documents include: U.S. Pat. No. 8,045,541, U.S. Pat. No. 8,009,592, U.S. Pat. No. 7,817,792, European Patent Publication No. 2149248 and Chinese Patent Publication No. 102170614A.

It is to be noted that acknowledgement of these documents does not constitute an admission that their teachings are considered to form part of the common general knowledge in the art.

It could be considered that current systems and methods do not utilise fully the power of a data call and a voice call to provide for an enriched calling experience as these are not generally utilised together simultaneously or near-simultaneously. For instances systems are known where the smart phone of a caller can run an “app” to display, for example, the profile of the caller as the call is received at the recipient's smart phone. However, such an “app” is static, carries no information about the voice call (for instance how it was set-up), and works only when a caller is known to the recipient. Thus the value of such data and voice calls when they provide independent information is not very high as it lacks context dependent information. The invention is defined in the independent claims. Some optional features of the invention are defined in the dependent claims.

Implementation of the techniques disclosed herein may provide significant technical advantages when compared with existing techniques. New systems and methods are described herein that can be used to provide for an enriched and informative voice call experience to a call recipient and, optionally, to the caller as well. Such an experience is enriched by simultaneous (or near-simultaneous) use of data and voice calls in a way that the data call provides information to the recipient that is about or related to the caller even when the caller is unknown to the recipient. Also the data call can carry additional useful information that the recipient may utilise for a voice call. An instance of such useful information includes details relating to a web-page (or the webpage itself) where the recipient's call-set-up link was clicked by the caller. Further, information pertinent to the data call can also be used to process the voice call appropriately; e.g., it can be used to route the voice call to a designated recipient device, for example a communications device of a sales person or directly to voice mail, amongst other options. Thus, these techniques may provide for intelligent call routing, depending on the information that the system collects about the user, their status and preferences.

Selection or activation of a link can be effected by any one of a number of ways. For example, a user may click (i.e. select) a hyperlink pointing at a web resource defined by a URL for the link, thereby to “select” the URL. Of course, the hyperlink may be presented to the user in a webpage, e-mail message, SMS, etc. by way of invitation for the recipient to be called, and any person wishing to contact the recipient may simply select or activate the link accordingly. Equivalently, the link may be made available for activation in an “app” that runs on the caller's communications device, instead of viewing a webpage in a browser running on the communications device. Internet—for example, Google—searches for the URL may also be sufficient. In another example, the user can select or activate the URL by reading a graphic, such as a QR code, the graphic directing the user's computer device to the web resource defined by the URL.

As used herein, we define a terminal, a computer or a communications device as a device that can provide for connectivity to the internet and/or and participate in voice communications, whether using VoIP or circuit-switched technologies such as PSTN calls. Thus, a terminal, computer or communications device can be a PC, laptop, netbook, mobile phone, smart phone, IP phone, gaming device, set-top box, iPAD, tablet PC and other such equivalent devices as any of these can be used to access the web for accessing web-sites as well as making calls using VoIP and other technologies. Typically, a computer uses LAN, routers, WLAN, DSL, cable, 3G, LTE, WiMAX, 3G+ etc. for data communication required to access the internet. A terminal or computer typically accesses the web and its contents, services and applications via an Internet browser, instances of which include Internet Explorer, Firefox, and Google Chrome etc.

We define a telephone that can be a land line (fixed line) phone, a cellular/mobile phone, a smart phone, a tablet phone, an IP phone, a Wi-Fi phone etc. It is a device that can be used for making/receiving a voice call via an electronic address consisting primarily of numeric strings or a phone number. Most mobile phones now are equipped with capability for voice calling as well as broadband connectivity (3G, LTE, 4G etc.) for internet browsing. Since the computing and communications devices, terminals, appliances etc. are convergent, these terms are used interchangeably without any loss of clarity, generality, or limitations to the invention described here.

The invention will now be described, by way of example only, and with reference to the accompanying drawings in which:

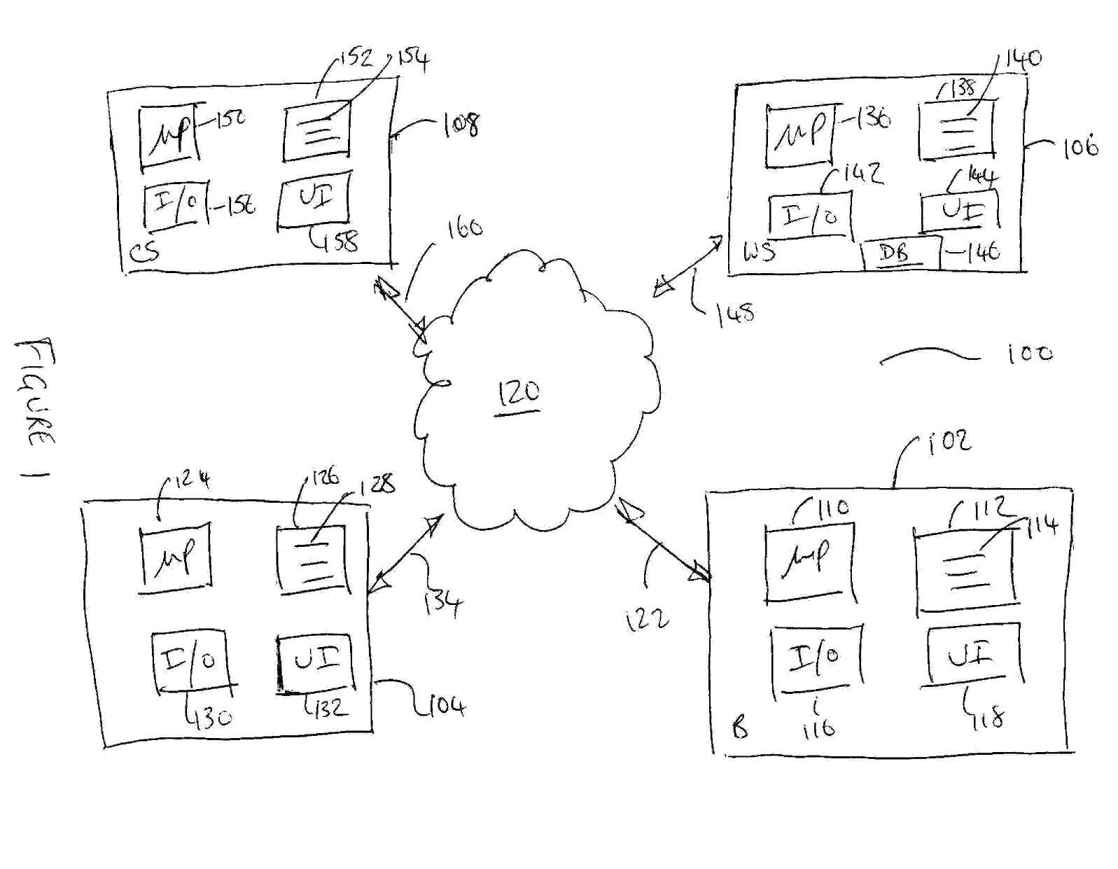

FIG. 1 is a schematic block diagram illustrating apparatus which permits simultaneous or near simultaneous voice and data calls between a calling device and a recipient device;

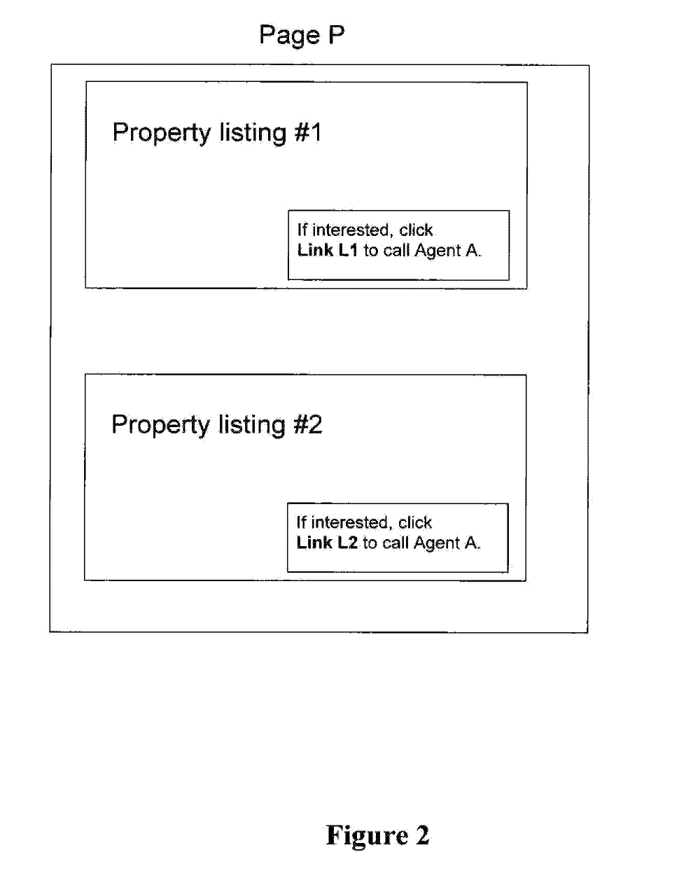

FIG. 2 is a schematic block diagram illustrating links available for activation in a web browser or on an app running on the calling device of FIG. 1;

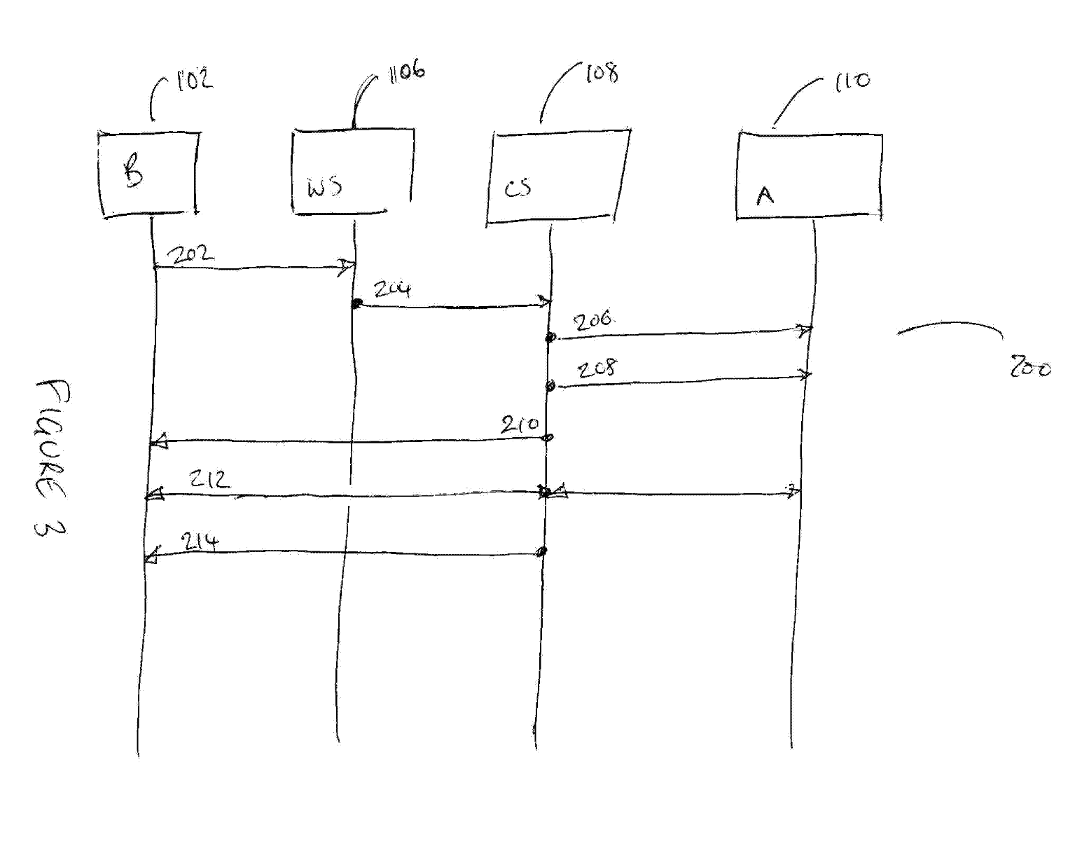

FIG. 3 is a timing sequence diagram illustrating a call setup procedure using the apparatus of FIG. 1;

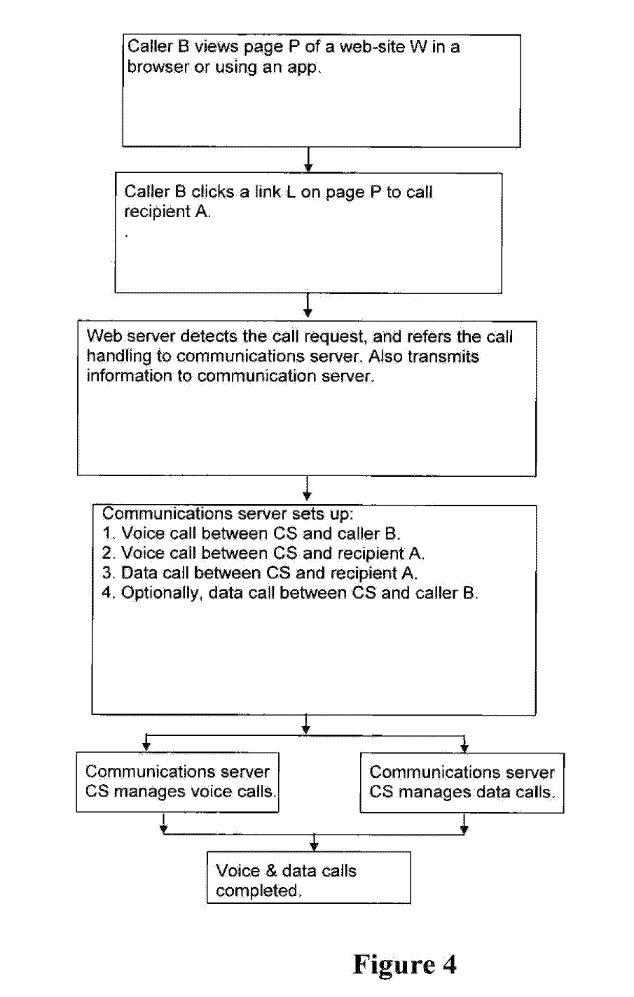

FIG. 4 is a flowchart illustrating a process for establishment of voice and data calls when a caller activates a link;

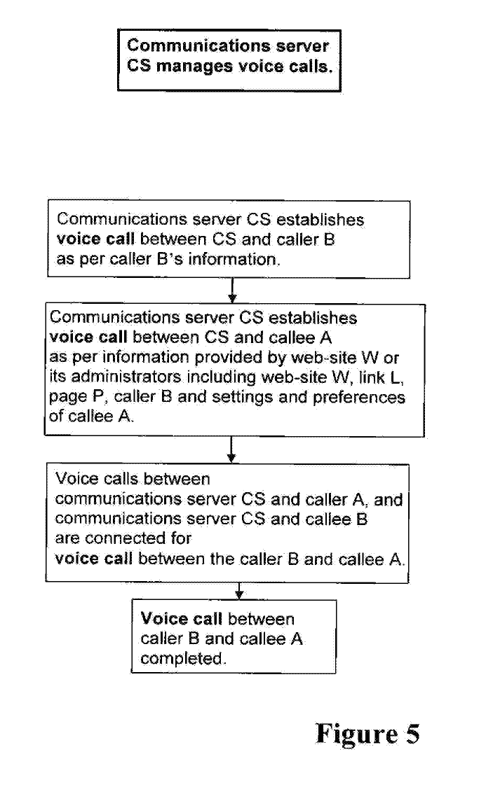

FIG. 5 is a flowchart illustrating a process for the establishment of a voice call when a caller activates a link; and

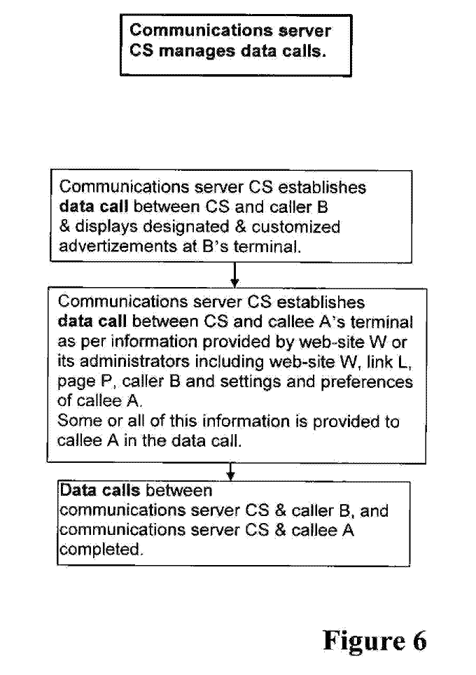

FIG. 6 is a flowchart illustrating a process for the establishment of a data call when a caller activates a link.

Turning first to FIG. 1, there is illustrated a system which permits simultaneous or near simultaneous (hereafter “simultaneous”) voice and data calls. When we say “simultaneous” voice and data calls, this means that voice and data transmission occurs concurrently. However, it does not necessarily mean that the techniques are restricted to the voice transmission and the data transmission being initiated simultaneously, although the present techniques certainly include within the scope such an arrangement. However, after one of the voice call and the data call is initiated, there may be some delay before the other of the voice call and the data call is initiated.

System 100 comprises a caller device (for caller B) 102, a recipient device (for recipient A) 104, a web server 106 and a communications server 108. Caller device 102 comprises a microprocessor 110, a memory 112 (e.g. a volatile memory such as a RAM) for the loading of executable instructions 114, the executable instructions defining the functionality the caller device 102 carries out under control of the processor 110. Caller device 102 also comprises an input/output module 116 allowing the calling device 102 to communicate with other devices. User interface 118 is provided for user control and may comprise, for example, conventional computing peripheral devices such as display monitors, computer keyboards and the like. If the caller device 102 is, say, a smart phone or tablet device, the user interface 118 is likely in the form of a touch panel display as is prevalent in many smart phone and other handheld devices. Caller device 102 is configured for communications through a data network 120 such as the Internet through communications channel/link 122, which may be a wireless link.

Recipient device 104 comprises a microprocessor 124, a memory 126 (e.g. a volatile memory such as a RAM) for the loading of executable instructions 128, the executable instructions defining the functionality the recipient device 104 carries out under control of the processor 124. Recipient device 104 also comprises an input/output module 130 allowing the recipient device 104 to communicate with other devices. User interface 132 is provided for user control and may comprise, for example, conventional computing peripheral devices such as display monitors, computer keyboards and the like. If the recipient device 104 is, say, a smart phone or tablet device, the user interface 132 is likely in the form of a touch panel display as is prevalent in many smart phone and other handheld devices. Recipient device 104 is configured for communications through a data network 120 via communications channel/link 148, which may be a wireless link.

It will be appreciated that caller device 102 and/or recipient device 104 may have the capabilities to make and receive both voice calls over a circuit switched network (e.g. cellular and/or PSTN network) or voice calls using VoIP protocols. And in this example, the devices are capable of partaking in “data calls”, acting as a device for accessing the Internet.

Web server 106 comprises a microprocessor 136, a memory 138 (e.g. a volatile memory such as a RAM) for the loading of executable instructions 140, the executable instructions defining the functionality the web server 106 carries out under control of the processor 136. Web server 106 also comprises an input/output module 142 allowing the web server 106 to communicate with other devices. User interface 144 is provided for user control and may comprise, for example, conventional computing peripheral devices such as display monitors, computer keyboards and the like. In the example of FIG. 1 web server 106 further comprises a database 146 for storing, for example, information relating to customers of a website hosted by the web server 106. Alternatively, database 146 may be hosted on a dedicated database server separate from web server 106, with the web server 106 and database server configured to communicate with one another. Web server 106 is configured for communications through data network 120 and communications channel/link 134, which may be a wired or a wireless link, or a combination of both.

Communications server 108 comprises a microprocessor 150, a memory 152 (e.g. a volatile memory such as a RAM) for the loading of executable instructions 154, the executable instructions defining the functionality the communications server 108 carries out under control of the processor 150. Communications server 108 also comprises an input/output module 156 allowing the communications server 108 to communicate with other devices. User interface 158 is provided for user control and may comprise, for example, conventional computing peripheral devices such as display monitors, computer keyboards and the like. Communications server 108 is configured for communications through data network 120 and communications channel/link 160, which may be a wired or a wireless link, or a combination of both.

The communications server 108 may be provided by the host of the website as a part of its services or it may partner with another provider to manage such communications.

The communications server 108 can be realised into two partitions or as two independent yet co-ordinated servers: one for managing voice calls and another for managing data calls. In this disclosure, we treat the communications server as one that can process both voice as well as data calls. This does not restrict the applicability of the invention as will be appreciated.

Referring to FIG. 2, consider a scenario where a real-estate agent A advertises an offer such as a property for rent or sale on one or more selected pages P of a web-site W. Thus, real estate agent A defines the content of the advertisement, and arranges for calls to be routed to themselves (or their delegates, as will be described in more detail below) upon activation of the link by an interested party B. (It will be appreciated that many other types of “offers” are also envisaged. For instance, links may be created to facilitate callers to call parties A to discuss anything that can be made available to parties B. This includes any goods or services that can be made available, whether for sale or for free, such as a call to a medical professional about a particular condition, counselling services or free helplines or the like.)

In this example, the advertisement on page P of the web-site W includes multiple links L1 and L2, but other numbers, including one link are envisaged. These links L1 and L2 are links that a person B (perhaps interested in a property on page P) can view on a display of caller device 102, such as a touch panel display user interface 118. Caller B can click (activate) one of the links on caller device 102 as a request to initiate a call to the agent A to discuss the property the link is associated with. One set of suitable techniques for initiating such a call are described in commonly-owned International Patent Application No. PCT/SG2013/000332, the contents of which are hereby incorporated by reference in their entirety. The advertisements by A for different properties can be different, and can even be located on different pages of the website, and the links for each property a dedicated link associated with the property in question. That is, each of the links will have an associated URL pointing at a web resource defined by the URL. In the example of FIG. 1, the links point to a web resource hosted by web server 106. A link L on page P may even be customized to page P and its contents. A page P may carry multiple advertisements and links for the recipient A, each link customised to the contents in its vicinity on page P. Web-server 106 may have or have access to information relating to caller B; for instance B may have had an account with the commercial entity responsible for maintaining web server 106, and caller B will have registered an account with web server 106 using, for example, device 102 or another device (phone, smart phone, tablet PC, laptop or other such devices).

Alternatively or additionally, the commercial entity that maintains web server 106 or a related third party may provide an “app” that runs on the device 102 of caller B that the caller B can use to obtain equivalent information and experience as he or she would do by visiting page P of the web-site W, and viewing and interacting with its contents to any web browser running on device 102. Thus, the view in FIG. 2 is such as might be seen by a user of calling device 102, when the calling device 102 is, say, a smart phone or a tablet device and running an app to view the contents of one or more pages P of the website hosted on web server 106.

In summary, when caller B clicks or otherwise activates one of the links L accessible at a web page hosted on web server 106 or an equivalent app view of the page on calling device 102, the link activation is picked up by web server 106. As noted above, the links L are dedicated links associated with the offer in question. Web server 106 is configured to determine that activation of that particular link is a request to initiate the voice communication session with recipient device 104 about the offer in question. Thus, web server 106 refers the call handling procedure to communications server 108, for communications server 108 to establish communications between caller device 102 and recipient device 104. That is, the communications server 108 that services the link L receives information that party B wishes to talk to party A, or a designated delegate as per A's settings and preferences. For instance, recipient A may choose to have the call routed as a VoIP call to one of his devices (laptop, desktop, tablet or smart phone), routed as a circuit switched technology call to, say, his mobile phone or to a landline or routed to, say, an assistant or a colleague. So communications server apparatus 108 may be configured to route the voice communication session to a recipient device in dependence of at least one preference setting defined by (or for) the call recipient. Supplementary information relating to the activation of the link is also transmitted by communications server 108 to recipient device 104. For instance, the supplementary information can be the web page where the caller B clicked the link L, or information relating to the page. For instance, if a real estate agent A has placed an advertisement relating to a property for sale, activation of the link by the caller at caller device 102 will mean that communications server 108 transmits information to recipient device 104 that the call is about that property. The recipient may receive data relating to this in the form of, for example, a visual alert such as a pop-up window on recipient device 104 and/or an audible alert.

The communications server 108 may also receive information related to B from web server 106 such as information relating to B's account with the website, B's browsing patterns on the website W and related profile etc. any and all of which may be extracted from database 146.

Based on the information that the communications server 108 receives upon caller B activating the link L, the communications server 108 initiates the process of voice and data call set-up, and then manages the calls. The process may include:

(i) caller B clicking the link L on a page P in web-site W or equivalently in an “app” running on B's device; and
(ii) the corresponding steps taken by communications server 108 to set up
(1) voice call between caller B and recipient A; and
(2) data calls between
   (2a) the communications server 108 and the caller B, and
   (2b) the communications server 108 and the recipient A
      will be discussed in further detail below.

The sequence 200 of steps for the setup of simultaneous voice and data calls using the system 100 is described with reference to FIG. 3.

Caller B navigates to a page P of website W, or corresponding page/view in an app. On page P caller B sees something of interest offered on page P—e.g. property listing #1—and wishes to discuss the offer with the party advertising the offer, in this case real estate agent A. In step 202 calling device 102 communicates to web server 104 the fact that a link L, associated with that particular offer, has been activated by caller B at device 102. It will be appreciated that a query may first be routed through a DNS server (not shown) to determine the correct web server at which the resource defined by the link is serviced/located. Web server 106 detects that the activation of the link is a request for a voice communication session between the caller B and the call recipient A, and refers handling of the call to communications server 108 at sequence step 204. At this point, web server 106 transmits information about the call request to the communications server 108. This information includes at least notification of activation of the link, and may also include details of the page which the link appears in, and other relevant information. Communications server 108 identifies the call recipient using the link information. For instance, communications server 108 may have, or have access to, a database (not shown) correlating URL information of the links with designated persons who wish to receive communications relating to the link. (Or, alternatively, this identification is carried out by web server 106, and the relevant information conveyed to communications server 108 at step 204 above, or separately.) At step 206, communications server 108 initiates a voice communication session with a recipient device 104. In this example, recipient device 104 is a smart phone belonging to a real estate agent A, and the voice communication session (whether having a video component or not can be initiated using VoIP protocols or standard circuit switched telephone techniques, such as a mobile cellular call. However, the techniques disclosed herein extend to, amongst others, routing the calls to a computing device (desktop or laptop computer belonging to real estate agent A), routing the call directly to a voicemail service associated with a real estate agent A or recipient device 104, an interactive voice response (IVR) system, a sales team, or any other delegate for the call that real estate agent A wishes to define.

Simultaneously or near simultaneously a data communication session is initiated with recipient device 104 at 208, and supplementary information comprising information relating to the offer is transmitted to the recipient device 104. The supplementary information may comprise information about the page on which the link is displayed. This information may relate to the activation of the link (e.g. the URL, or the IP address the URL points to, the page itself, or meta data relating to the page, or information relating to the caller B) is transmitted from communications server 108 to recipient device 104. Thus, real estate agent A (or his delegate) is able to see what the call is about, and/or whom the call is from.

This may be particularly beneficial. For instance, if communications server 108 transmits supplementary data to recipient device 104 that the call is about, say, a highly-prestigious property (meaning a high-value transaction) the recipient can prioritise receipt of the call over other activities he or she may be engaged in at the time the call is initiated. Conversely, if communications server 108 transmits supplementary data to recipient device 104 that the call is about, say, a less-prestigious property (meaning a lower-value transaction), the recipient is in a better position to decide whether or not to screen the call.

In at least one example, communications server 108 is configured to allow the owner of the link L (real estate agent A) to define rules concerning the handling of a call initiated by activation selection of the link L. For instance, the real estate agent A may not wish to receive calls about certain types of properties at certain times of the day. Thus, the agent configures communications server 108 (or arranges for it to be configured by the administrators of the server) such that calls relating to, for example, offers below a certain value are routed directly to voicemail after 5 PM. Or, and by way of another example, when communications server 108 transmits to recipient device 104 information relating to the caller B, one of the devices—whether web server 106, communications server 108 or recipient device 104—is configured to determine that caller B belongs to a certain demographic, such as, say, being a high net worth individual so that real estate agent A is motivated to take the call personally and promptly.

In another example, recipient A may define that communications server 108 is to call recipient device 104 (e.g. recipient A's mobile telephone) from a particular number (or from a group of numbers) based on the identity of caller B (if, caller B is judged to be a high net worth individual, or otherwise a high-profile customer).

Once real estate agent A accepts the incoming call, communications server 108 initiates a voice communication session with caller device 102 at step 210, and then communications server 108 bridges a voice communication session between calling device 102 and recipient device 110 at step 212.

Optionally, a second data communication session may be initiated at 214 between communications server 108 and calling device 102, where a second set of supplementary information is transmitted to caller device 102, this second supplementary information being defined by the call recipient. This data call is optional, and may be dependent upon system settings, the capabilities of the recipient device 104 and/or caller device 102 and pre-defined settings made by recipient A and/or caller B. For instance, communications server 108 may communicate to caller device 102 other information which may be of interest to caller B and/or other information that recipient A desires caller B to review. This may take the form of, for example, information relating to offers similar to the offer associated with the link L activated by caller B. For instance, information relating to other properties similar to, or in the same value range as, the property associated with link L may be transmitted by communications server 108 to caller device 102. Of course, caller B may have the option of reviewing this additional information, receiving the information and then not reviewing it, or declining to accept it at the device 102.

Optionally, extra steps may be taken prior to step 202 above. For instance, at the caller device 102 where caller B clicked or otherwise activated the link L, communications server 108 transmits a page or a pop-up to be rendered or displayed at device 102 for B to enter details of the device on which he wishes to participate in the voice communication session. Thus, caller B may enter his mobile telephone number so that the call may be routed via cellular communications to his mobile telephone (which in fact may be caller device 102) or, say, an instant messaging/VoIP identifier, such as a Skype™ identifier, so that the voice communications can be initiated using the instant message/VoIP protocol. That is, the communications server apparatus 108 may be configured to allow the caller to define a caller device 102 for the voice communication session. Also, the communications server apparatus 108 may be configured to prompt the caller for a definition of a caller device, after activation of the link for the voice communication session.

As a further example, caller device 102 and/or recipient device 104 may be configured to participate in voice communication sessions with a communications application embedded within the webpage or app code for facilitating the communication session. When the page renders in, say, a web browser of one of the devices, the communications application runs in the web browser, perhaps in the background voice and/or video communication may be enabled from the device. Such techniques are described in commonly-assigned International Patent Application No. PCT/SG2013/000332. When implementing such techniques, a VoIP call does not require any specialised software—e.g. Skype™—to be installed or running on caller device 102. Thus, responsive to activation of the link, communications server 108 may be configured to transmit page information to the calling device, the page information comprising application code for an application for channelling the communication session between the caller device and the recipient device.

In one example, caller B is not required to input the details of the device on which he wishes to participate in the voice communication session. For example, caller B may have the option of skipping the entry of this information. In such instances, web server 106 and/or communications server 108 are able to determine which device on which to route the call to caller B based on pre-defined account settings stored in database 146. Also the pop-up window can be timed out after a pre-set time.

Thus it will be appreciated that there has been described, with reference to FIGS. 1 to 3, a communications server apparatus 108 comprising a processor 150 and a memory 152, the communications server apparatus being configured, under control of the processor, to execute instructions 154 stored in the memory: to receive, over a communications channel 160, link information relating to a caller input, the caller input being activation of a link L in a page by a caller, the link being associated with an offer, and activation of the link being a request for a voice communication session between the caller and a call recipient about the offer; to identify the call recipient using the link information; to initiate the voice communication session between a caller device 102 associated with the caller and a recipient device 104 associated with the call recipient; and to transmit, to the recipient device, supplementary information relating to the activation of the link.

Further, there has also been described in a method, performed in a communications server apparatus 108, the method comprising, under control of the processor 150 of the communications server apparatus: receiving, over the communications channel 160, link information relating to a caller input, the caller input being activation of a link L in a page by a caller, the link being associated with an offer, and activation of the link being a request for a voice communication session between the caller and a call recipient about the offer; identifying the call recipient using the link information; initiating the voice communication session between a caller device 102 associated with the caller and a recipient device 104 associated with the call recipient; and transmitting, to the recipient device 104 the, supplementary information relating to the activation of the link.

These techniques also relate to the provision of the web server 106, the caller device 102 and the recipient device 104 for implementation of the described techniques.

FIG. 4 illustrates in high-level an algorithm for setting up voice and data calls using the communications server of FIG. 1.

Thus, caller B views page P of a website W in a browser or an app running on device 102. Caller B activates a link L on page P to call recipient A. Subsequently, web server 106 detects the call and refers the call handling to communications server 108. Web server 106 may also transmit information to communications server 108 on one or more of the following:
information about caller B;
information about link L that was activated by caller B;
information about page P on which link L was rendered, and/or the page itself; and
information about the website W.

Of course it will be appreciated that web server 106 and communications server 108 may be configured to exchange other related and pertinent information required or desirable in setting up the voice and data call, and as may be desired by recipient A.

Based on the information received from web server 106, recipient A's settings and preferences, communications server 108 sets up:

1. A voice call between communications server 108 and the caller device 102;
2. A voice call between communications server 108 and the recipient device 104;
3. A data call between communications server 108 and recipient device 104; and (optionally)
4. A data call between communications server 108 and caller device 102.

Voice calls in 1 and 2 above are bridged by communications server 108 for voice conversations, which may or may not include a video component. In the optional data call 4, communications server 108 transmits, for example, designated and customised advertisements defined by recipient A, whether at caller device 102 or another device. Thus, the communications server apparatus 108 may be configured to transmit second supplementary information to the caller device 102, the second supplementary information being defined by the recipient.

Communications server 108 manages the voice calls and the data call(s) in parallel with one another until the calls are completed.

FIG. 5 illustrates an algorithm for the process of a voice call between caller B and recipient A as set up and managed by communications server 108.

Communications server 108 establishes a voice call between the server 108 and caller device 102, with the device 102 being defined by the caller B as described above. Communications server 108 establishes a voice call between the server and recipient device 104 in accordance with information provided by web server 106 (which may include information relating to the website, the link L, the page P the caller B and the settings and preferences of recipient A as described above.

Voice calls between communications server 108 and caller device 102 and between communications server 108 and recipient device 104 are connected to be bridged between caller device 102 and recipient device 104. The call is managed until ended. FIG. 6 illustrates an algorithm for the process of a data call. Optionally, communications server 108 establishes a data call between the server 108 and caller device 102. In this optional data call, designated and customised advertisements (or other relevant information), which may be defined by recipient A or, say, someone associated with recipient A is transmitted to caller device 102 for display thereat. Communications server 108 establishes a data call between communications server 108 and recipient device 104 in accordance with predefined preferences described above. A data call is then managed by communications server 108 to recipient device 104 and, optionally, a data call is managed by communications server 108 to caller device 102.

In the data call between communications server 108 and recipient device 104, data which may be transmitted includes one or more of the following:

1. Information about caller B, perhaps obtained from database 146, or otherwise input by caller B in the call setup procedure described above;
2. The webpage P where link L was clicked/activated by caller B, or information relating thereto;
3. Webpages similar to webpage P containing information that may be of interest to caller B. Recipient A then has the option to filter these (e.g. manually) and take note of pages that he may wish to bring to the attention of caller B;
4. The browsing history of caller B and/information relating to his profile/account information; and
5. The history of users similar in profile to caller B, stored in database 146.

The communications server 108 may also take into account recipient A's preferences and compilation of the information to be communicated to recipient A in the data call.

The data call is set-up by the communications server 108 between itself and one or more user terminals 104 of party A. The data call may precede, follow or be established simultaneously with the voice call as per system and/or recipient A's preferences and settings. Such data can be based on push or pull model. Recipient A's terminal 104 for the data call may also run an “app” to enable and facilitate the data call. Finally, the data call may take into account the capabilities of A's terminal 104 as well as the data network.

As stated earlier, the communications server for data call and voice call can be same or different. Also the terminals of recipient A for voice call and data call can also be different. For example, the voice call may be received by A at his mobile while the data call may be received at either his mobile or his office computer or both. The voice call to A may also be set up in a find-me-follow-me manner such that more than one number is listed by A and they ring in a per-configured manner till call to A is answered. It may even be a conference call.

The link L can also be clicked by the caller B in an “app” running on B's terminal 102 as provided by web-site W or another party for the purpose. In such a case, the “app” on B's terminal 102 may automatically communicate B's voice calling information to the communications server 108 along with other pertinent information. In such a case, the call may even be initiated by the caller B's terminal 102.

It will be appreciated that the invention has been described by way of example only and that various modifications may be made to the techniques described above without departing from the spirit and scope of the invention.

1. Communications server apparatus comprising a processor and a memory, the communications server apparatus being configured, under control of the processor, to execute instructions stored in the memory:
to receive, over a communications channel, link information relating to a caller input, the caller input being activation of a link in a page by a caller, the link being associated with an offer, and activation of the link being a request for a voice communication session between the caller and a call recipient about the offer;
to identify the call recipient using the link information;
to initiate the voice communication session between a caller device associated with the caller and a recipient device associated with the call recipient; and
to transmit, to the recipient device, supplementary information relating to the activation of the link, the supplementary information being for display in a visual alert on a display of the recipient device.

2. The communications server apparatus of claim 1, configured for the voice communication session to be initiated with the recipient device concurrently with display of the visual alert on the display of the recipient device.

3. The communications server apparatus of claim 1, configured to transmit, to the recipient device, supplementary information comprising information relating to the offer.

4. The communications server apparatus of claim 1, configured to transmit, to the recipient device, supplementary information comprising information about the page on which the link is displayed.

5. The communications server apparatus of claim 1, configured to transmit, to the recipient device, supplementary information comprising information relating to the caller.

6. The communications server apparatus of claim 5, configured to receive information relating to the caller from a hosting server associated with the page.

7. The communications server apparatus of claim 1, configured to allow the caller to define a caller device for the voice communication session.

8. The communications server apparatus of claim 1, configured to prompt the caller for a definition of a caller device, after activation of the link for the voice communication session.

9. The communications server apparatus of claim 1, configured to allow the recipient to define a recipient device for the voice communication session.

10. The communications server apparatus of claim 1, configured to route the voice communication session to a recipient device in dependence of at least one preference setting defined by or for the call recipient.

11. The communications server apparatus of claim 1, configured, responsive to activation of the link, to transmit page information to the calling device, the page information comprising application code for an application for channelling the communication session between the caller device and the recipient device.

12. The communications server apparatus of claim 1, configured to transmit second supplementary information to the caller device, the second supplementary information being defined by the recipient.

13. A method, performed in a communications server apparatus, the method comprising, under control of the processor of the communications server apparatus:
receiving, over the communications channel, link information relating to a caller input, the caller input being activation of a link in a page by a caller, the link being associated with an offer, and activation of the link being a request for a voice communication session between the caller and a call recipient about the offer;
identifying the call recipient using the link information;
initiating the voice communication session between a caller device associated with the caller and a recipient device associated with the call recipient; and
transmitting, to the recipient device, supplementary information relating to the activation of the link, the supplementary information being for display in a visual alert on a display of the recipient device.

14. A computer program product comprising a non-transitory computer readable medium having stored thereon computer-readable instructions for executing, under control of a processing device, the method of claim 13.

15. A computer program comprising instructions for a computing device to execute the instructions under control of the processing device to perform the method of claim 13.
